(19) United States
(12) Patent Application Publication
(10) Pub. No.: US 2011/0200828 A1
(43) Pub. Date: Aug. 18, 2011

(54) HYDROPHILIC COATINGS FOR MEDICAL DEVICES

(75) Inventors: Junwei Li, Collegeville, PA (US); William J. Work, Huntingdon Valley, PA (US)

(73) Assignee: BIOCOAT INCORPORATED, Horsham, PA (US)

(21) Appl. No.: 13/021,811

(22) Filed: Feb. 7, 2011

Related U.S. Application Data
(60) Provisional application No. 61/304,961, filed on Feb. 16, 2010.

(51) Int. Cl. B32B 27/08; B32B 27/00; B32B 27/30; B32B 27/40; B32B 27/18

(52) U.S. Cl. 428/414; 428/704; 428/522; 428/474.4; 428/423.1

(57) ABSTRACT

Biocompatible, lubricious, highly durable coatings for medical devices are formed from a highly adherent base-coat and a hydrophilic top-coat that is chemically grafted to the base-coat and has a chemically cross-linked structure. The base-coat constitutes a carboxylic acid containing polymer. The top-coat includes a carboxylic acid containing hydrophilic polymer and chromium (III) ion as the cross-linking agent. The coating possesses biocompatibility and gamma ray-sterilization stability. The coated products in aqueous media display an unmatched combination of lubricity, abrasion resistance, and chemical stability.

### CROSS-REFERENCE TO PRIOR APPLICATION

Priority is claimed from U.S. Provisional Patent Application Ser. No. 61/304,961, filed Feb. 16, 2010, the entire disclosure of which is hereby incorporated by reference.

### BACKGROUND OF THE INVENTION

The present invention relates to the field of hydrophilic coatings that are applied to medical devices, especially devices intended to be implanted, temporarily or permanently, in the body.

Among the many advances in medical practice in recent years is the development of medical devices that supplement the surgeon's skills. Examples of these are a variety of vascular catheters and guide wires that can be used to treat remote areas of the circulatory system otherwise available only by major surgery. Another is the stent, a device that reinforces arterial walls and prevents occlusion after angioplasty. Another is the intra-ocular lens that restores youthful eyesight to the elderly afflicted with cataracts. Heart valves, artificial pacemakers, and orthopedic implants are among a lengthening list of other devices.

Nearly all of the above-described devices are constructed of plastics and metals that were never intended to invade, and sometimes reside for prolonged periods in, the human body. They present surfaces that bear little or no resemblance to those of human organs, which are generally hydrophilic, slippery and biocompatible. The penalty imposed on invasive devices that are not biocompatible is that they tend to be treated as foreign objects by the body's defensive systems. Inflammation and thrombosis often result.

Equally important for devices that must be inserted and moved through body tissues is their lubricity. Most metals and plastics have poor lubricity against body tissues, which results in mechanical abrasion and discomfort when the device is passed over the tissue.

Device surfaces designed and manufactured from such materials can be made biocompatible, as well as hydrophilic and slippery, by properly designed coatings. Thus, the way has been opened to construct medical devices from conventional plastics and metals having the particular physical properties required, and then to apply suitable coatings to impart the desired properties to their surfaces.

Polysaccharides have been shown to be useful in making hydrophilic, lubricious coatings on substrates. Such coatings are described in U.S. Pat. Nos. 4,801,475, 5,023,114, 5,037,677, and 6,673,453, the disclosures of which are hereby incorporated by reference. In general, these patents disclose bilaminar coatings comprising a primary coat that adheres tightly to a plastic substrate, and a top-coat which comprises a polysaccharide which is hydrophilic, lubricious and durable. The primary coat is sometimes called a “tie-coat” because it ties the top-coat to the substrate; it is also known as a base-coat. Both of the terms “tie-coat” and “base-coat” are considered equivalent in this specification.

In the coatings described in the above cited patents, the base-coat and the top-coat are grafted together with covalent bonds and retain their individual identities even after grafting. These bilaminar coatings can be used on catheters, guide wires, prosthetic devices, intra-ocular lenses, or other devices that are permanently or temporarily inserted into the body.

Polysaccharides used as hydrophilic coatings in the above-cited patents are natural products. They are biodegradable and may also be degraded by free radicals or water. There are limitations associated with coatings made of polysaccharides. For example, a finished polysaccharide coating on a medical device is susceptible to degradation by a gamma-sterilization process, enzymatic degradation, oxidation or hydrolysis. Synthetic polymers, on the other hand, are much more stable, especially those have a carbon-carbon backbone, such as polyacrylates. A synthetic polymer coating also has a longer shelf-life for both the coating solution and the finished coating on medical devices.

It is desirable for some applications to have a lubricious coating made of synthetic polymers for the benefits above-mentioned. Hydrophilic polymers, such as poly(acrylic acid) and its copolymers have often been proposed to make lubricious, hydrophilic coatings because of their ability to generate a hydrated layer on the surface. Many attempts have been made to utilize poly(acrylic acid) coatings on medical devices. The methods in U.S. Pat. Nos. 4,642,267 and 4,990,357 include physical blends of poly(acrylic acid) copolymer with a polyurethane dispersion. This method has the drawback that the interpolymer network physically attaching the hydrophilic polymer to the substrate often breaks down upon prolonged turbulent flow or soaking and the hydrophilic species can be washed away thereby rendering the article insufficiently lubricous.

Other methods invented to utilize poly(acrylic acid) as a hydrophilic coating on a surface include radiation grafting of a carboxylic acid monomer and its polymer, as described in U.S. Pat. Nos. 2,999,056, 5,531,715, 5,789,018, and 6,221,061, and EP 0669837, plasma grafting of an acrylic acid monomer in EP 0220919, and also methods using a primer layer containing isocyanate, aziridine, amine and hydroxyl functional groups to anchor poly(acrylic acid), as stated in U.S. Pat. Nos. 5,091,205, 5,136,616, 5,509,899, 5,702,754, 6,048,620, 6,558,798, 6,709,706, 6,087,416, 6,534,559, and European Patent Nos. 0379156, 0480809, 0728487, and 0963761.

The prior art poly(acrylic acid) coatings exhibit relatively poor lubricity and/or durability because of insufficient hydrophilic polymer coating thickness and/or poor binding to the surface. It is hard to achieve a high density surface coverage by either grafting through photo-initiated polymerization or surface chemical attachment of polymers. Multiple-repeated coating processes may increase the thickness of photo-initiated polymerization coating, but will greatly decrease productivity and add to the cost of manufacture. Using a cross-linker can increase the thickness of a hydrophilic coating considerably. The prior art includes methods to cross-link poly(acrylic acid) coatings by photo radiation and by the reaction of polyfunctional reactive compound, such as melamine and aziridines, as described in U.S. Pat. Nos. 5,531,715 and 6,558,798, and European Patent No. 533821. However, the cross-linked hydrophilic coatings in the art often face a trade-off between lubricity and abrasion resistance, which are both indispensable properties for a hydrophilic coating. A highly cross-linked coating has poor lubricity because of its low capacity of hydration and reduced mobility of polymer segments in aqueous media. A coating with a low cross-linking density has a high swelling ratio, which generally leads to poor abrasion resistance and weak mechanical strength.

The cross-linker used for the hydrophilic polymer will decide the nature of the cross-linking chemistry and the structure of the cross-linked product, and therefore the properties of the coating. The suitable cross-linker must also produce a product that is stable in the media that the medical devices will encounter in practice. And the cross-linking reaction must not require severe conditions, such as very high temperatures or toxic catalysts. Therefore, it is critical to select an appropriate cross-linker for the hydrophilic coating to achieve the satisfactory combination of lubricity, durability, biocompatibility, and stability in biological media.

### SUMMARY OF THE INVENTION

The present invention comprises a substrate, typically a device intended to be implanted temporarily or permanently in the human body, having a bilaminar coating. The bilaminar coating includes a base-coat that firmly adheres to the substrate and a top-coat that is chemically grafted to the base-coat and cross-linked by chromium (III) ions. The top-coat forms a hydrophilic, lubricious layer on the surface of the substrate.

In the present invention, the top-coat comprises a mixture of a water soluble chromium (III) compound and a water-soluble polymer containing carboxylic acid groups, which forms a coating with a three dimensional network structure when it is cured. Another aspect of the invention is that the crosslinking reaction proceeds slowly, if at all, in the aqueous mixture of the carboxylic acid containing polymer and chromium (III) compound. It is only during the drying and curing processes that the carboxylic acid containing polymer becomes highly crosslinked.

The hydrophilic top-coat is chemically cross-linked and at the same time grafted to a highly adherent base-coat. An important feature of the present invention is that a unique cross-linker is used in the top-coat, which is responsible for the high durability of the hydrated coating. The mechanical strength of the hydrated coating is greatly increased by cross-linking the structure, while its lubricity is retained. The coated products display a combination of adhesion, abrasion resistance, water resistance, gamma-sterilization stability, biocompatibility, and lubricity. The cross-linker, chromium (III) ion, is believed to react with the carboxylate groups in top-coat polymer to form a network structure that can be water swollen when contacted with an aqueous solution.

The base-coat and/or top-coat also contain functional groups that enable the two coats to be chemically grafted to each other. Preferably, the base-coat polymer contains multifunctional isocyanate and multifunctional aziridine groups that react with the top-coat polymer and form chemical bonds between the top-coat and the base-coat.

The present invention therefore has the primary objective of providing a lubricious, biocompatible coating for a medical device.

The invention has the further objective of providing a coating as described above, wherein the coating can be sterilized by gamma or E-beam radiation.

The invention has the further objective of providing a coating as described above, wherein the hydrated coating is highly durable, resistant to water and salt solutions such as PBS and abrasion resistant.

The reader skilled in the art will recognize other objects and advantages of the present invention from a reading of the following brief description of the drawings, the detailed description of the invention, and the appended claims.

### BRIEF DESCRIPTION OF THE DRAWINGS

FIG. 1 provides a graph summarizing test results for one of the coatings of the present invention, namely the chromium (III) acetate hydroxide cross-linked poly(acrylic acid) coating, as tested by using a pinch tester, the graph illustrating the reduction in friction achieved by such coating.

FIG. 2 provides a graph similar to that of FIG. 1, except that the coating was tested after being gamma-ray sterilized.

FIG. 3 provides a graph showing the effect of E-beam sterilization on the dynamic friction coefficient of the chromium (III) sulfate cross-linked poly(acrylic acid) coating, as tested by using a pinch tester, and as explained in Example 11.

FIG. 4 provides a graph showing the effect of E-beam sterilization on the durability of the chromium (III) sulfate cross-linked poly(acrylic acid) coating, as tested by using a pinch tester, and as explained in Example 11.

FIG. 5 provides a graph showing the effect of ethylene oxide sterilization on the dynamic friction coefficient of the chromium (III) sulfate cross-linked poly(acrylic acid) coating, as tested by using a pinch tester, and as explained in Example 12.

FIG. 6 provides a graph showing the effect of ethylene oxide sterilization on the durability of the chromium (III) sulfate cross-linked poly(acrylic acid) coating, as tested by using a pinch tester, and as explained in Example 12.

FIG. 7 provides a graph showing the stability of the chromium (III) sulfate cross-linked poly(acrylic acid) coating, by showing the effect, after soaking in 37° C. PBS solution, on the average dynamic friction coefficient of the coating, as explained in Example 13.

FIG. 8 provides a graph showing the stability of the chromium (III) sulfate cross-linked poly(acrylic acid) coating, by showing the effect of soaking in 37° C. PBS solution on the coating durability, as explained in Example 13.

FIG. 9 provides a graph showing the performance of the coating of the present invention under conditions of accelerated aging, specifically showing the effect of aging at 52° C. on the average dynamic friction coefficient of the coating, as explained in Example 14.

FIG. 10 provides a graph showing the performance of the coating of the present invention under conditions of accelerated aging, specifically showing the effect of aging at 52° C. on the coating durability, as explained in Example 14.

### DETAILED DESCRIPTION OF THE INVENTION

The requirements for any coating intended for use on medical devices will be set forth and explained first. The specification will then show how the present invention fulfills these requirements.

The coating of the present invention must have the following properties:

(1) It must be able, on drying, to form a continuous, adherent film of good integrity on the surface of the material to be coated. This means that the minimum film-forming temperature of the coating solution must be lower than the expected drying temperature to be used during device fabrication.

(2) The formed polymer film must be flexible and adherent enough to conform without rupture to the bending and twisting of the coated device under the expected conditions of use.

(3) When the coated device is immersed for long periods in aqueous media such as human blood, the film must not weaken or lose its integrity.

(4) The coating must present a hydrophilic, biocompatible surface and be firmly and securely bound to itself and to the substrate so that no fragments or harmful leachable can contaminate an aqueous medium such as human blood.

(5) The coating must withstand some acceptable form of sterilization without loss of integrity, durability, biocompatibility, or lubricity.

A coating which satisfies the above requirements is made as described below.

The coatings of the present invention have three chemical characteristics, namely 1) the chemical composition of the acrylic copolymer or polyurethane (the “base-coat”) to be used in coating the substrate, and 2) the composition of the top-coat, which generates a lubricious and biocompatible external surface on the composite coating, and 3) the cross-linker for the top-coat, which greatly improves its lubricity and durability.

These characteristics are discussed in order, below.

A requirement of the base-coat composition of the present invention is that it displays carboxyl or other functional groups with a frequency sufficient to enable cross-linking of the base-coat when desired and to enable the base-coat to become grafted to the selected hydrophilic top-coat by the action of a suitable grafting or cross-linking agent. Such functional groups are preferably carboxylic acids introduced by one or more acidic monomers. The mole percentage of such functional monomers should be as low as will serve the purpose, because such groups can have the undesirable effect of increasing water sensitivity and consequently weaken the coating. The acid functionality will be introduced by copolymerization of acrylic acid, methacrylic acid, itaconic acid, acryloxypropionic acid, maleic anhydride or any other acidic monomer capable of copolymerization with suitable monomers to form a hydrophobic polymer. In any case, the mole percentage of acidic monomers will most desirably be in the range of 0.2 to 10 mole percent of the total monomer composition.

In the case of an acrylic base-coat, the coating can be either a solvent-based acrylate polymer solution or an aqueous acrylate polymer colloidal dispersion. The base-coat will normally be formulated with a polyfunctional crosslinking agent, such as a polyfunctional aziridine, a polyfunctional isocyanate, or epoxy. The polyfunctional aziridine in the base-coat is not only used to cross-link the base-coat polymer, but also to react with the carboxylic acid containing top-coat polymer at the interface and tie the two coats together by chemical bonding.

The acrylic polymer base-coat can be solvent-based and the functional group may also be selected as a hydroxylic monomer, such as hydroxyethyl methacrylate, in addition to acidic monomer, and the cross-linking and grafting agent can be a polyfunctional isocyanate.

Suitable acrylic polymer base-coats described above include those supplied under the trademarks Hydak B-23K, Hydak B-500, Hydak S-103, and Hydak DC-8 by Biocoat, Inc., of Horsham, Pa. Hydak B-23K is a base-coat that contains hydroxyl functionality and is suitably cross-linked with a polyisocyanate. Hydak B-500 and Hydak S-103 are base-coats that contain both hydroxyl and carboxylic acid functionality and are suitably cross-linked by a mixture of a polyfunctional aziridine and a polyfunctional isocyanate. Hydak DC-8 is a base-coat that contains carboxylic acid functionality and is suitably cross-linked with a polyfunctional aziridine. Suitable base-coats may also be acrylic coating solutions or water dispersions provided by other suppliers that are capable of reacting with polyfunctional aziridines. Mixtures of acrylic base-coats also may be suitable.

Suitable base-coats can also be polyurethane dispersions in water. Such polyurethanes comprise those with built-in organic acid groups that are reactive to polyfunctional aziridines. Preferred organic acid groups are carboxylic acids or their partially neutralized salts. The polyfunctional aziridine in the base-coat is not only used to cross-link the base-coat polymer, but also to react with the top-coat polymer at the interface and tie the two coats together by chemical bonding. By this means, a top-coat containing carboxylic acid groups can be grafted on the base-coating layer. Examples of suitable polyurethane base-coats include those supplied: under the trademarks NeoRez R1010, NeoRez R551, NeoRez R563, NeoRez R600, NeoRez R940, NeoRez R960, NeoRez R9621, NeoRez R9637, NeoRez R967, NeoRez R9679, and NeoRez R974 by DSM, under the trademarks Sancure 20040, Sancure 20037F, Sancure PC-52, Sancure 1049C, Sancure 11525, Sancure 12929, Sancure 12954, Sancure 13094HS, Sancure 20025, Sancure 777F, Sancure 815, Sancure 815D, Sancure 777, Sancure 825, Sancure 898, and Sancure 20041 by Lubrizol.

Another specific class of polymers which may be used as the base-coat for the hydrophilic coating described in this disclosure are acrylate-urethane hybrids, for example those supplied under the trademarks NeoPac 9699 by DSM and Sancure AU 4010 by Lubrizol.

The base-coats described above are used with polyfunctional aziridines. Examples of such polyfunctional aziridines are supplied under the trademarks Neocryl CX-100 by DSM and XAMA-7 by Bayer AG. The base-coat formulation may also include suitable polyfunctional isocyanates as cross-linking agents in addition to polyfunctional aziridines.

The top-coat includes a hydrophilic polymer that contains multiple carboxylic acid functional groups derived from one or more carboxylic acid monomers, or its partially neutralized salts. Examples of top-coat polymers are poly(acrylic acid), poly(methacrylic acid), poly(acrylic acid-co-acrylamide), poly(methylvinyl ether-maleic anhydride) and their salts. The top-coat may also include other materials selected from carboxylic acid containing polymers, including copolymers consisting of one or more of carboxylic acid containing monomers such as acrylic acid, methacrylic acid, itaconic acid, acryloxypropionic acid, isocrotonic acid, 3-butene-1,2,3-tricarboxylic acid, and maleic anhydride, and any acidic monomer capable of copolymerization with suitable monomers to form hydrophilic polymers. The acid containing polymer is ready to be grafted onto the base-coat layer specified above. Particularly the acid containing top-coat is reacted with polyfunctional aziridines used in the base-coat. The hydrophilic polymers in the top-coat are, therefore, chemically bonded to the base-coat surface.

The weight average molecular weight of the carboxylic acid containing, hydrophilic polymer may be 50,000-10,000,000 Daltons. Preferably, the weight average molecular weight is 100,000 to 5,000,000 Daltons. Most preferably, the weight average molecular weight of the carboxylic acid containing, hydrophilic polymer is 200,000 to 1,000,000 Daltons.

The invented coating system comprises a unique cross-linker, chromium (III) ion, in the top-coat. Chromium (III) ion is found to be an effective cross-linker for the carboxylic acid containing top-coat and makes the hydrophilic top-coat polymer insoluble in aqueous media after drying and curing. The formed top-coat is readily hydrated to form a hydrogel layer on the surface of the substrate and the coating demonstrates excellent lubricity in aqueous media and remarkable durability for wear resistance.

The chromium (III) ion in the formulated top-coat can be selected from any water soluble chromium(III) compound. Examples include the following chromium (III) compounds: chromium(III) acetate hydroxide, chromium(III) chloride, chromium(III) nitrate, chromium(III) phosphate, chromium(III) potassium sulfate dodecahydrate, chromium(III) sulfate and chromium(III) tris(2,2,6,6-tetramethyl-3,5-heptanedionate).

Chromium (III) ion in the top-coat may also be prepared from the reduction of a chromium (VI) compound in aqueous solution with a reducing agent such as sodium bisulfite, thiourea, or by other oxidation or reduction reactions to form chromium (III) from a different chromium oxidation state.

The ratio of chromium (III) ion to polymer in the top-coat is between 0.25 to 10% by weight. The pH of the top-coat solution can be from 2.3 to 10.0. The preferred pH of the top-coat solution is from 3.5 to 5.0.

The top-coat solution is applied after the base-coat has dried and formed a water insoluble coating layer. After the top coat has been applied, the base-plus-top coated materials are baked in an oven at 50-120° C. to fully cure the base-coat and top-coat.

The presence of chromium (III) ion in the top-coat greatly increases the amount of hydrophilic polymer attached to the base-coat layer. Without the added chromium(III) cross-linker, the amount of hydrophilic polymer attached to the base-coat would be limited to the amount of aqueous top-coat deposited and the number of reactive groups on the base-coat surface. The hydrophilic polymers are responsible for the lubricious properties of the coating when it contacts an aqueous medium. Insufficient coverage of hydrophilic polymer would confer a poor friction-reducing property. The cross-linked structure of the top-coat helps to retain much more hydrophilic polymer and thus provides surface with good lubricity when hydrated.

Moreover, the chromium (III) cross-linked carboxylic acid containing top-coat demonstrates a combination of good lubricity and durability to wear resistance. Both of these properties are critical for successful friction-reducing coatings. There is generally a trade-off between lubricity and durability for cross-linked coatings. Higher cross-linking density leads to higher friction and lower cross-linking density leads to poor durability. In the invented system, chromium (III) cross-linked carboxylic acid containing hydrophilic coatings overcome this problem and provide a range of cross-linking density which possesses both low friction and high durability.

The description above introduces an improved coating system in which a new cross-linking strategy is invented. When used, the coating greatly reduces the friction of medical devices when they are inserted and passed over tissues, which, therefore, prevents mechanical abrasion and discomfort.

In the invented coating system, a hydrophilic top-coat provides lubricity for the coated medical devices when contacted with aqueous media. The base-coat used is an intermediate layer between the functional hydrophilic top-coat and the medical device surface. The base-coat possesses good adhesion to the medical device substrate. Suitable base-coats can be acrylic polymers, polyurethanes, or acrylate-urethane copolymers. The useful base-coats are organic acid containing acrylic polymers, polyurethane dispersions and acrylate-urethane copolymers, which are reactive with polyfunctional aziridines. The aziridine compound in the base-coat formulation is utilized to graft carboxylic acid containing top-coat polymers to the base-coat polymer. Therefore the hydrophilic polymer in the top-coat is chemically attached to the base-coat layer. The cured base-coat absorbs a very small amount of water, so it can maintain its adhesion when the coated medical devices are used in aqueous media. At the same time the top-coat, which is fixed on the base-coat, is ready to be hydrated and provides lubricity.

The utilization of chromium (III) ion as the cross-linker for the carboxylic acid containing hydrophilic polymer described in this specification is a novel improvement over the prior art. In particular, the unique cross-linking chemistry of the coating ensures the combination of excellent lubricity and durability. The chromium (III) cross-linked synthetic polymer coating also possesses exceptional resistance to gamma or E-beam radiation sterilization procedures. After gamma or E-beam sterilization, the hydrophilic coating retains its lubricity and durability. The coating system is also proven to be non-cytotoxic by the MEM Elution test.

The invention will be further illustrated in the following non-limiting examples representing presently preferred embodiments of the invention.

### Example 1

A solution was prepared as follows: 0.5 gram of 0.1% (wt/wt) chromium (III) acetate hydroxide solution was added to 2 gram of 5% (wt/wt) poly(acrylic acid) solution and thoroughly mixed. The mixture was cast into a polypropylene beaker and baked at 60° C. for 16 hours. The dry film was soaked in 20 ml deionized water for 3 hours. The film turned into a swollen, water-insoluble gel. In a control experiment, 2 g of 5% (wt/wt) poly(acrylic acid) solution was cast and baked under the same conditions. The dry film was then soaked in 20 ml deionized water and it completely dissolved within 10 minutes. A swollen gel-like structure indicates that the poly(acrylic acid) and chromium (III) acetate hydroxide formed a cross-linked polymer network which absorbs water and expands but is insoluble.

The cross-linked poly(acrylic acid) film prepared as above was soaked in 20 ml 5M NaCl. The film was swollen and maintained its gel-like structure after soaking in the salt solution for 6 days at room temperature. With the excessive amount of sodium ion present in 5M NaCl solution, if the chromium (III) ion interacted conically with carboxylate groups it should have been mostly replaced by sodium and the gel should have dissolved. The fact that the hydrogel did not dissolve in 5M NaCl solution indicated that the nature of cross-linking between chromium (III) ion, a trivalent cation, and poly(acrylic acid) is not a purely ionic interaction.

The poly(acrylic acid) had a molecular weight of 450,000 Daltons and was purchased from Polysciences, Inc. Chromium(III) acetate hydroxide was from Sigma-Aldrich. 5% (wt/wt) poly(acrylic acid) and 0.1% (wt/wt) Cr(III) acetate hydroxide solutions were prepared by dissolving each compound in deionized water.

### Example 2

A solution was prepared as follows: 0.075 gram of 5% (wt/wt) chromium (III) acetate hydroxide solution was added to 5 gram of 5% (wt/wt) poly(acrylic acid) solution and thoroughly mixed. The mixture was cast into polypropylene beakers and baked at 80° C. for 16 hours. The dry films obtained were then soaked in 20 ml water, PBS buffer, and 1% (wt/wt) Na₄ (EDTA) solution (tetrasodium(ethylenediamine tetraacetic acid), respectively. The swelling ratios of the gels were measured after they were soaked for 5 hours and 7 days, respectively. The soluble fractions were measured by comparing the dry weight of the gel before and after soaking. It is known that the polymer gel swelling ratio in a good solvent is correlated to its cross-linking density. The smaller the swelling ratio, the higher the cross-linking density. The soluble fraction indicates the amount of material not cross-linked into the coating and which dissolves when soaked in an aqueous medium. The results in Table 1 indicate that the hydrogel is very stable in water and PBS buffer. The swelling ratio increased over time in 1% (wt/wt) Na4 (EDTA) solution, which indicated a slow degradation of the cross-linked structure, while the soluble fraction of the gel was not much higher than that in PBS after 7 days.

TABLE 1
The stability of the chromium (III)
acetate hydroxide cross-linked hydrogel.

| | | | | | 1% (wt/wt) | |
|---|---|---|---|---|---|---|
| | Water | | PBS | | Na₄(EDTA) | |
| Time | Swelling | Soluble | Swelling | Soluble | Swelling | Soluble |
| soaked | ratio | fraction | ratio | fraction | ratio | fraction |
| 5 hours | 5.5 | 8% | 18 | 18% | 38 | |
| 7 days | 6.0 | 7% | 19 | 18% | 67 | 21% |

The swelling ratio was measured by weighing the swollen gel after blotting with a paper towel and then drying the gel at 110° C. in a convection oven for 1 hour followed by reweighing the dry gel after baking. The following equation was used:

swelling ratio=(weight of swollen gel)/(weight of dry gel)

The PBS buffer was prepared as follows: Na₂HPO₄ 3.64 gram, NaH₂PO₄.H₂O 0.75 gram, NaCl 22.98 gram, KCl 1.16 gram, H₂O 2700 gram.

The reaction between chromium (III) and poly(acrylic acid) probably forms coordinate covalent bonds. The carboxylate groups in poly(acrylic acid) replace acetate under high temperature and forms the coordination structure with chromium (III). The coordination constant, K, of chromium (III) and acetate is ca. 10^{6.8}. The coordination constant of chromium (III) and EDTA is ca. 10²³, which may explain the slow degradation of the gel in 1% (wt/wt) Na₄ (EDTA) solution.

### Example 3

In this example, a bilaminar coating was applied to a polyester rod in which Cr(III) acetate hydroxide cross-linked poly(acrylic acid) was used as the top-coat. The utilization of such coating is intended to reduce the friction between the medical device and contacted tissue.

A base-coat composition was prepared by adding the following ingredients successively to a beaker under proper agitation until thoroughly mixed.

Hydak B-500 28.4 g, Desmodur N 75 BA/X 1.95 g, 10% (wt/wt) Neocryl CX-100 0.44 g, Propylene glycol monomethyl ether (PM) acetate, 70 g

Hydak B-500 is 30% wt acrylic polymer solutions in PM acetate, manufactured by Biocoat, Inc. Desmodur N 75 BA/X is from Bayer MaterialScience, an aliphatic polyisocyanate resin based on hexamethylene diisocyanate. Neocryl CX-100 is a polyaziridine sold by DSM Corporation. 10% (wt/wt) CX-100 solution was prepared by dissolving it in PM acetate.

A top-coat composition was prepared as follows:

Poly(acrylic acid) 2 g, water 98 g, 5% (wt/wt) Cr(III) acetate hydroxide aqueous solution 1.2 g.

A 4% (wt/wt) NH₄OH solution was used to adjust the pH of the solution to 4.8.

Copolyester (PETG) rods of diameter ⅛ inches purchased from McMaster Carr were used as a substrate for the bilaminar coating. The rods were wiped with isopropyl alcohol to clean the surface and allowed to dry before applying the coating.

Both base-coat and top-coat were applied to the substrate by a dip-coating method. PETG rods were dipped into the coating solution then withdrawn at a speed of 0.2 inch per second and a thin layer of coating solution remained on the substrate surface. The samples were dried in a 75° C. oven for 20 min after the base-coat was applied. The top-coat was applied at a speed of 0.2 inch per second and the bilaminar coating cured for 2 hours at 80° C. The cured samples were washed with 0.5% (wt/wt) NaHCO₃ and water, respectively, and dried at 60° C. for 20 min.

In a control experiment, a top-coat solution without Cr(III) acetate hydroxide was used:

Poly(acrylic acid) 1 g, water 99 g.

A 4% (wt/wt) NH₄OH solution was used to adjust the pH of the solution to 4.8.

The same dip-coating, curing and washing procedures were used for the control samples as were used for the chromium cross-linked samples.

### Example 4

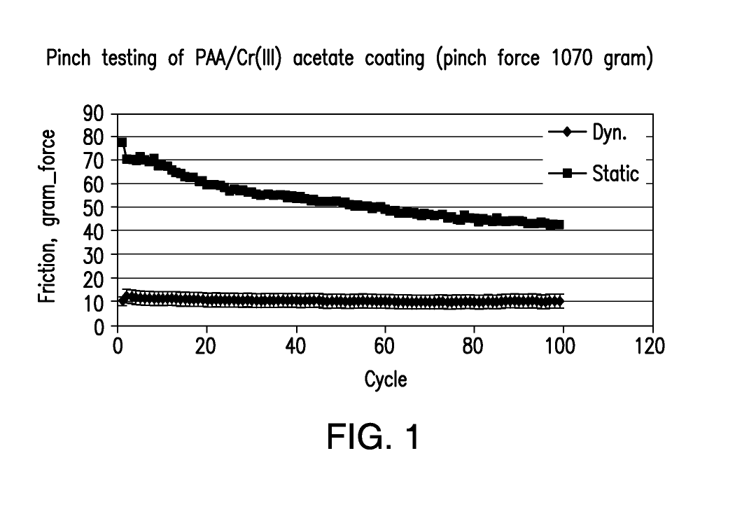

In this example, the friction reducing properties of the coated samples prepared in Example 3 were tested in a pinch tester. The tester is designed to measure the friction of a medical device when it is wetted with phosphate-buffered saline at 37° C. and drawn through two pads clamped at a desired force, the details of which are described below. The durability of the coating was also evaluated by monitoring the change of friction over repeated testing of the same sample. The test was conducted under a pinch force of 1070 grams and the length of sample tested was 3 inches. For each test cycle the dynamic friction is the average value of the frictional force of the entire tested length. The results of samples prepared in Example 3 are shown in Table 2. The dynamic friction shown in Table 2 is the average of 20 cycles. The friction of the poly(acrylic acid) cross-linked with chromium (III) acetate hydroxide coating was remarkably low. Compared to pure poly(acrylic acid), adding of chromium (III) acetate to the top-coat formulation reduced the friction by a factor of four. The durability of the poly(acrylic acid) and chromium (III) acetate hydroxide coating was also excellent, as shown in FIG. 1. There was essentially no change of the dynamic friction property of coated sample over 100 cycles of testing.

TABLE 2
Dynamic friction of coated PETG rods
measured under 1070 gram pinch force

| Top-coat formulation | Dynamic friction, grams |
|---|---|
| Uncoated | 327 |
| Poly(acrylic acid) | 47 |
| Poly(acrylic acid) and | 11 |
| chromium acetate hydroxide | |

The pinch tester mentioned above is a device designed for measuring the performance of lubricious coatings on medical devices such as catheters, guide wires, and similar products. The tester has two pads and a mechanism that can apply an adjustable pinch force that clamps these two pads together. A sample, such as a piece of catheter, is pulled through two pads. The pulling rate is controlled by a digital force tester (Chatillon TCD225). The digital force tester is also used to measure and record the pulling force, which is essentially the friction between the sample surface and the pads. The test is conducted while the pads and part of the tested sample were all submerged in 37° C. phosphate-buffered saline. An appropriate length of sample is pulled through the clamped pads. Then the sample is re-inserted and brought back to the starting position so that the test can be repeated. The friction of inserting is normally similar to that of pulling. However, a flexible sample will require opened pads while it returns to the starting position. The digital force tester records both static friction (the initial value when the test is started) and dynamic friction (the amount of friction as the test sample is in motion). When repeated cycles of testing are conducted, the growth of the friction during the test is calculated and used as an indicator of the durability of the coating. The smaller the rate of growth of friction over repeat testing, the more durable the coating.

### Example 5

In this Example, the amount of poly(acrylic acid) grafted on the substrate was measured for the samples prepared in Example 3. The assay used was developed by James B. Johnston (Journal of Biomedical Materials Research B. V53, 2000: 188-191) and can be briefly explained as follows: the counter-ion of carboxylate in poly(acrylic acid) coating is fully exchanged by a cationic dye and the exchanged dye in the coating is then completely eluted by a NaCl solution, and the amount of coating is calculated based on the amount of dye in the collected eluate, which is determined spectroscopically. It should be pointed out that the coated samples are soaked in TBO dye and 8M urea solution for 1 hour to fully exchange the cations, which is longer than the time used in the reference paper.

The results of the poly(acrylic acid) grafting density are shown in Table 3. It is very clear that the coating with chromium (III) cross-linker has much more poly(acrylic acid) attached on the substrate surface than that without cross-linker. That is also consistent with the friction properties revealed by the pinch testing. When there is no cross-linker in the top-coat formulation, the amount of polymer grafted by the functional groups present on a base-coat/primer coat surface is insufficient to impart a high level of lubricity. Adding chromium (III) ion cross-linker greatly increases the amount of poly(acrylic acid) attached on the substrate surface. The thicker coating possesses good wear resistance as proved by the pinch testing which we believe is attributed to the nature of the cross-linking product between chromium (III) ion and poly(acrylic acid).

TABLE 3
Effect of adding chromium (III) acetate hydroxide in coating
formulation on the amount of poly(acrylic acid) retained
in the finished coating after washing with water

| | Poly(acrylic acid) coating density, |
|---|---|
| Coating solution | microgram/cm² |
| Poly(acrylic acid) | 1 |
| Poly(acrylic acid) and | 58 |
| chromium acetate hydroxide | |

### Example 6

A solution was prepared as follows: 0.015 gram of 5% (wt/wt) chromium (III) acetate hydroxide solution was added to 10 gram of 0.5% (wt/wt) poly(acrylic acid) solution and thoroughly mixed. The pH of the mixture was adjusted to 4.6 with 1M NaOH. Three grams of the mixture were cast into a polypropylene beaker and baked at 80° C. for 16 hours. The dry film was soaked in 20 ml deionized water for 3 hours, and the film turned into a swollen, water insoluble gel.

The poly(acrylic acid) had Mw of 1,000,000 Daltons and was sold by Polysciences, Inc. A 0.5% (wt/wt) polyacrylic solution was prepared by dissolving the powder in deionized water.

A bilaminar coating was applied to a polyester rod, on which Cr(III) acetate hydroxide cross-linked poly(acrylic acid) with Mw of 1,000,000 Daltons was used as the top-coat. The utilization of such coating is to reduce the friction between the medical device and contacted tissue.

A base-coat composition was prepared by adding the following ingredients successively to a beaker under proper agitation until thoroughly mixed.

Hydak B-500 18.4 g, Desmodur N 75 BA/X 1.24 g, Neocryl CX-100 0.17 g, Propylene glycol monomethyl ether (PM) acetate, 34 g

A top-coat composition was prepared as follows:

Poly(acrylic acid) (Mw=1,000,000 Daltons) 0.3 g, water 60 g, 5% (wt/wt) Cr(III) acetate hydroxide aqueous solution 0.09 g, 20% CF-10 0.3 g.

A 4% (wt/wt) NH₄OH solution was used to adjust the pH of the solution to 4.8.

CF-10 is Triton CF-10, a non-ionic surfactant made by Dow Chemical. Chemically it is the benzyl-polyethylene glycol (1,1,3,3-tetramethylbutylphenyl)ether.

Copolyester (PETG) rods of diameter ⅛ inches purchased from McMaster Carr were used as a substrate for the bilaminar coating. The rods were wiped with isopropyl alcohol to clean the surface and dried before applying coating.

Both the base-coat and top-coat were applied to the substrate by dip-coating. PETG rods were dipped into the base-coat solution then pulled out at a speed of 0.2 inch per second. A thin layer of coating solution remained on the substrate surface. The samples were dried in a 60° C. oven for 20 min after the base-coat was applied. Then the top-coat was applied and the resulting bilaminar coating cured for 16 hours at 60° C. The cured samples were washed with 0.5% (wt/wt) NaHCO₃ and water, respectively, and then dried at 60° C. for 20 min.

The coated sample was tested in the pinch tester as described in Example 4 and it showed a dynamic friction of 12 gram under pinch force of 1070 g. The sample was tested for 100 cycles and showed 0.03 gram decrease of dynamic friction per cycle. Therefore, the coating had both good lubricity and durability.

### Example 7

A solution was prepared as follows: 0.03 gram of 5% (wt/wt) chromium (III) acetate hydroxide solution was added to 5 gram of a (wt/wt) poly(acrylic acid-co-2-hydroxyethyl methacrylate) solution and thoroughly mixed. One gram of the mixture was cast into a polypropylene beaker and baked at 80° C. for 16 hours. The dry film was soaked in 20 ml deionized water for 5 hours. The film turned into a swollen, water insoluble gel.

The poly(acrylic acid-co-2-hydroxyethyl methacrylate) copolymer had 80% (wt/wt) of acrylic acid and was made by Biocoat, Inc.

### Example 8

A solution was prepared as follows: 0.075 gram of 5% (wt/wt) chromium (III) acetate hydroxide solution was added to 50 gram of 0.5% (wt/wt) poly(acrylic acid-co-acrylamide) solution, 0.25 g of 20% (wt/wt) of CF-10 was also added. The solution was then thoroughly mixed. The pH of the mixture solution was adjusted to 4.8 by 4% (wt/wt) NH₄OH. Three grams of the mixture were cast into a polypropylene beaker and baked at 80° C. for 16 hours. The dry film was soaked in 20 ml deionized water for 5 hours whereupon the film turned into a swollen, water insoluble gel.

The poly(acrylic acid-co-acrylamide) sodium salt copolymer had 40% (wt/wt) of acrylic acid and a Mw of 10,000,000 Daltons, and was purchased from Polysciences, Inc. A 0.5% (wt/wt) poly(acrylic acid-co-acrylamide) sodium salt solution was prepared by dissolving the copolymer in deionized water. The pH of the solution was adjusted to 2.8 by using Amberlite IR 120H resin (supplied by Rohm and Haas).

The solution of poly(acrylic acid-co-acrylamide) prepared above was used to coat PETG rods. The same base-coat formulation and dip-coating, curing and washing procedures as those in Example 7 were used. The coated sample was tested in the pinch tester as described in Example 4 and it showed a dynamic friction of 15 gram under pinch force of 1070 g. The sample was tested for 100 cycles and showed 0.01 gram increase of dynamic friction per cycle. Therefore the coating had both good lubricity and durability.

### Example 9

In this example, the cytotoxicity of a bilaminar coating was tested. Cr(III) sulfate cross-linked poly(acrylic acid) was used as the top-coat.

A base-coat composition was prepared by adding the following ingredients successively to a beaker under proper agitation until thoroughly mixed.

Hydak B-500 35.6 g, Desmodur N 75 BA/X 2.34 g, Neocryl CX-100 0.32 g, Propylene glycol monomethyl ether (PM) acetate, 84 g.

A top-coat composition was prepared as follows:

Poly(acrylic acid) (Mw 450,000) 3 g, water 117 g, 5% (wt/wt) Cr(III) sulfate aqueous solution 0.6 g, 20% (wt/wt) CF-10 0.075 g.

A 4% (wt/wt) NH₄OH solution was used to adjust the pH of the solution to 4.1.

Polyester film of thickness of 0.01 inches purchased from McMaster Carr was used as a substrate for the bilaminar coating. The films were wiped with isopropyl alcohol to clean the surface and dried before applying coating.

Both base-coat and top-coat were applied to the substrate by the dip-coating method. Two pieces of polyester film, 52×58 mm² each, were dipped into the base-coat solution then pulled out at speed of 0.1 inch per second. A thin layer of coating solution adhered to the substrate surface. The samples were dried in a 60° C. oven for 20 min after the base-coat was applied. Then the top-coat was applied at speed of 0.1 inch per second and cured for 2 hours at 60° C. The cured samples were washed with 0.5% (wt/wt) NaHCO₃ and water, respectively, and then dried at 60° C. for 30 min.

The coated samples were evaluated by Nelson Laboratories for cytotoxicity by the MEM Elution Test. The samples made according to this Example were reported to be non-cytotoxic.

### Example 10

In this example, the performance of a bilaminar coating after gamma-ray sterilization was tested, in which a Cr(III) acetate hydroxide cross-linked poly(acrylic acid) was used as the top-coat.

A base-coat composition was prepared by adding the following ingredients successively to a beaker under proper agitation until thoroughly mixed.

Hydak B-500 73.4 g, Desmodur N 75 BA/X 4.96 g, Neocryl CX-100 0.68 g, Propylene glycol monomethyl ether (PM) acetate, 136 g

A top-coat composition was prepared as follows:

Poly(acrylic acid) 1.6 g, water 78.4 g, 5% (wt/wt) Cr(III) acetate hydroxide aqueous solution 0.48 g.

A 4% (wt/wt) NH₄OH solution was used to adjust the pH of the solution to 4.8.

Copolyester (PETG) rods of diameter ⅛ inches purchased from McMaster Carr were used as a substrate for the bilaminar coating. The rods were wiped with isopropyl alcohol to clean the surface and dried before applying coating.

Both base-coat and top-coat were applied to the substrate by dip-coating. PETG rods were dipped into coating solutions then pulled out at speed of 0.2 inch per second. A thin layer of coating solution remained on the substrate surface. The samples were dried in a 60° C. oven for 10 min after the base-coat was applied. Then the top-coat was applied and cured for 2 hours at 60° C. The cured samples were washed with 0.5% (wt/wt) NaHCO₃ and water, respectively, and then dried at 60° C.

The coated samples were gamma-ray sterilized. The sterilization was conducted as an engineering run by Steris Isomedix using a regular dose for medical devices (approximately 25 kGy). The properties of the coating were evaluated after gamma-ray sterilization.

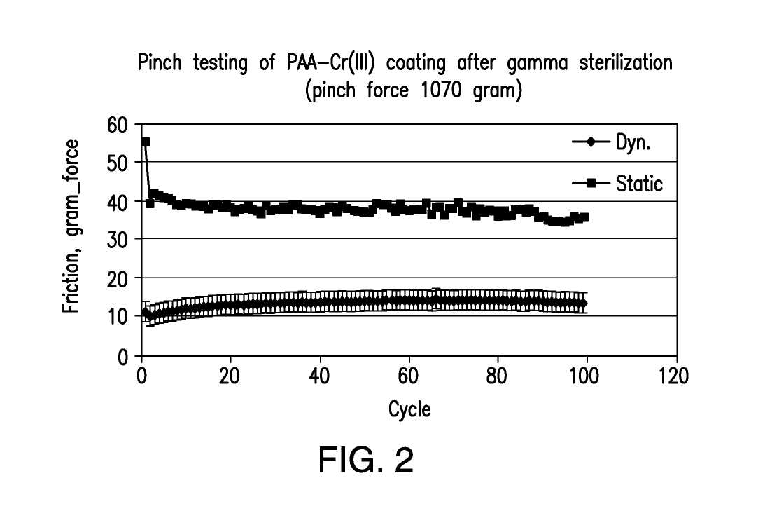

Table 4 shows the bound poly(acrylic acid) on the substrate surface and the coating swelling ratio in deionized water. The results in Table 4 indicate that the Cr (III) ion cross-linked coating can withstand the gamma irradiation sterilization. The amount of poly(acrylic acid) coating and the cross-linking density of the sterilized samples were similar to those of the samples that were not sterilized. The friction properties of the coating after gamma sterilization were tested by the pinch tester and the results are shown in FIG. 2. The gamma-ray sterilized coating has excellent lubricity and durability.

TABLE 4
Effect of gamma ray sterilization on chromium
(III) cross-linked poly(acrylic acid) coating

| Test | Gamma-sterilized | Not sterilized |
|---|---|---|
| Poly(acrylic acid) coating | 40 | 35 |
| density, microgram/cm² | | |
| Coating swelling ratio | 34 | 29 |

### Example 11

In this example, the performance of a bilaminar coating after E-Beam sterilization was tested in which Cr(III) sulfate cross-linked poly(acrylic acid) was used as the top-coat.

A base-coat composition was prepared by adding the following ingredients successively to a beaker under proper agitation until thoroughly mixed.

Hydak B-500 35.6 g, Desmodur N 75 BA/X 2.34 g, Neocryl CX-100 0.32 g, Propylene glycol monomethyl ether (PM) acetate, 88 g.

A top-coat composition was prepared as follows:

Poly(acrylic acid) (Mw 450,000) 2.5 g, water 97.5 g, 5% (WA) Cr(III) sulfate aqueous solution 0.5 g, 20% (wt/wt) CF-10 0.063 g.

A 4% (wt/wt) NH₄OH solution was used to adjust the pH of the solution to 4.1.

Copolyester (PETG) rods of diameter ⅛ inches purchased from McMaster Carr were used as a substrate for the bilaminar coating. The rods were wiped with isopropyl alcohol to clean the surface and dried before applying coating.

Both base-coat and top-coat were applied to the substrate by dip-coating at a withdraw speed of 0.2 inch per second. PETG rods were dipped into coating solutions then pulled out. A thin layer of coating solution remained on the substrate surface. The samples were dried in a 60° C. oven for 10 min after the base-coat was applied. Then the top-coat was applied and cured for 2 hours at 60° C. The cured samples were washed with 0.5% (wt/wt) NaHCO₃ and water, respectively, and then dried at 60° C.

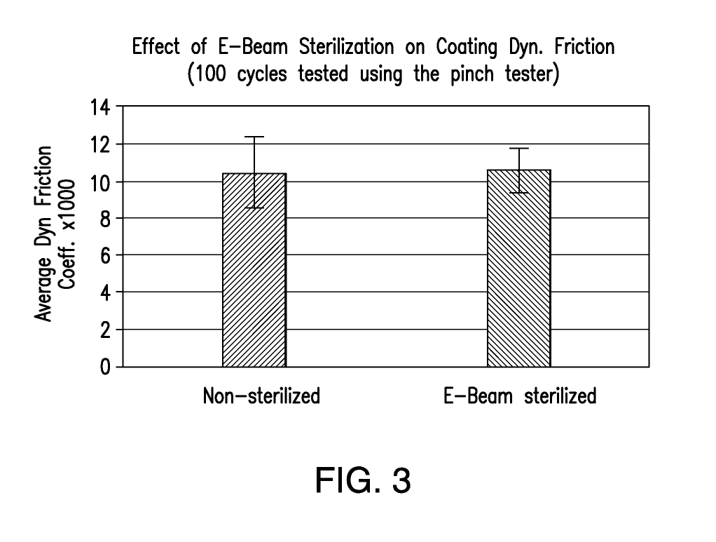

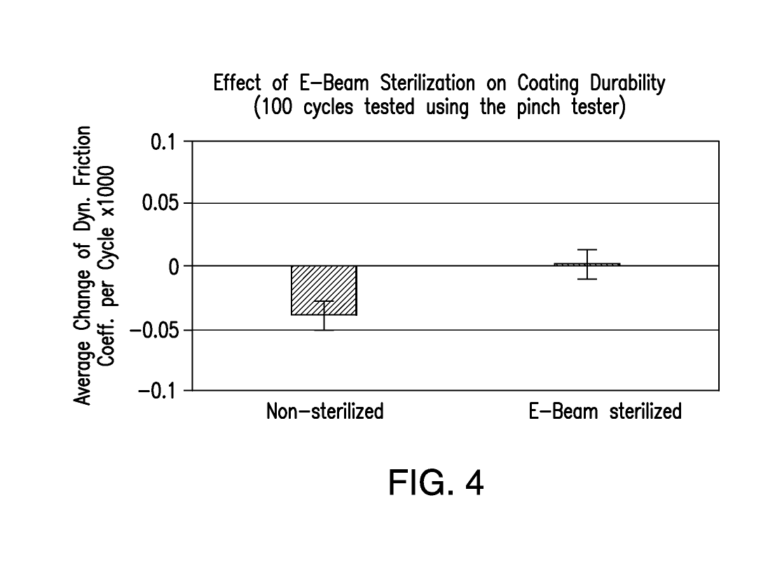

The coated samples were E-Beam sterilized. The sterilization was conducted by BeamOne, LLC using a dose of 25 kGy+/−10%. The properties of the coating were evaluated by using the pinch tester described in Example 4. Six samples after E-Beam sterilization were tested. Six samples without sterilization were also tested as controls. Three pinch forces, 770 grams, 1070 grams and 1370 grams, were used for testing the six samples, in which two of the samples were tested using one of the pinch forces. One hundred cycles were conducted for each testing. The average friction coefficient of the 100 cycles was calculated, so was the growth of the friction coefficient per cycle. The results are shown in FIGS. 3 and 4. Pinch testing results showed that the E-Beam sterilized samples had a average dynamic friction coefficient of 10.6×10⁻³, similar to that of the non-sterilized samples. In FIG. 4 the E-Beam sterilized coating showed good durability, indicated by an average growth of friction coefficient per cycle of 0.002 (+/−0.016)×10⁻³ in the 100-cycle testing.

### Example 12

In this example, the performance of a bilaminar coating after ethylene oxide sterilization was tested in which Cr(III) sulfate cross-linked poly(acrylic acid) was used as the top-coat.

The sample preparation was the same as that in Example 11.

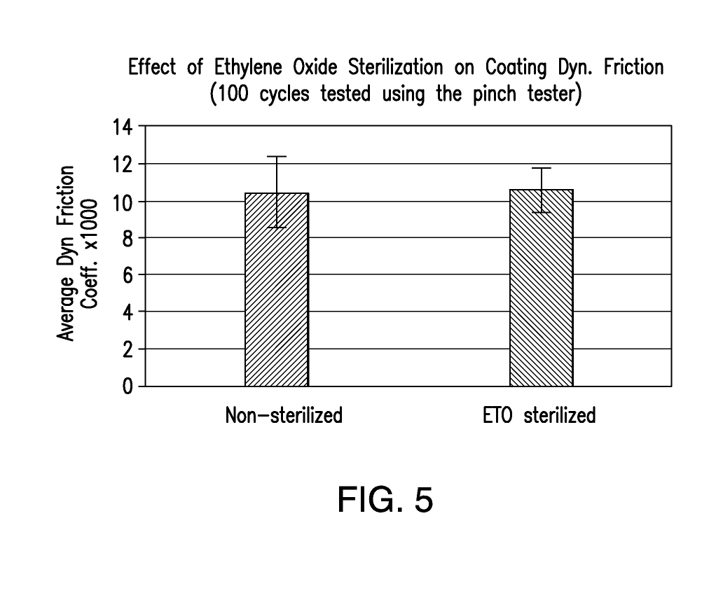

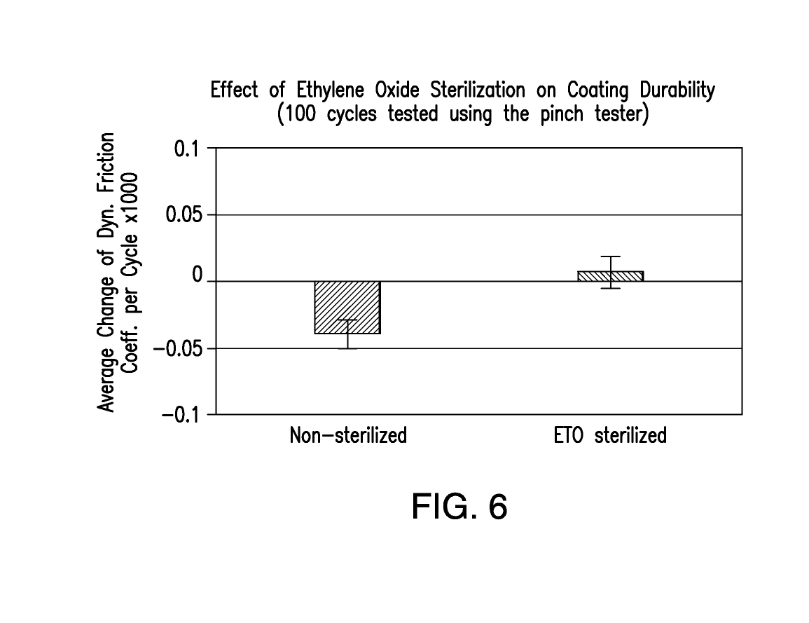

The coated samples were sterilized by ethylene oxide gas. The sterilization was conducted by Anderson Scientific using its standard greater than 16-hour sterilization process at 50+/−3° C. The properties of the coating were evaluated by using the pinch tester described in Example 4. Six samples after ethylene oxide sterilization were tested. Six samples without sterilization were also tested as control. Three pinch forces, 770 grams, 1070 grams and 1370 grams, were used for testing the six samples, in which two of the samples were tested using one of the pinch forces. One hundred cycles were conducted for each testing. The average friction coefficient of the 100 cycles was calculated, so was the growth of the friction coefficient per cycle. The results are shown in FIGS. 5 and 6. Pinch testing results showed that the ethylene oxide sterilized samples had an average dynamic friction coefficient of 10.7×10⁻³, similar to the non-sterilized samples. In FIG. 6, the ethylene oxide sterilized coating showed good durability, indicated by an average growth of friction coefficient per cycle of 0.007 (+/−0.012)×10⁻³ in the 100-cycle testing.

### Example 13

In this example, the stability of the bilaminar coating in Phosphate buffered saline (PBS) solution was tested in which Cr(III) sulfate cross-linked poly(acrylic acid) was used as the top-coat.

The sample preparation was the same as that in Example 11.

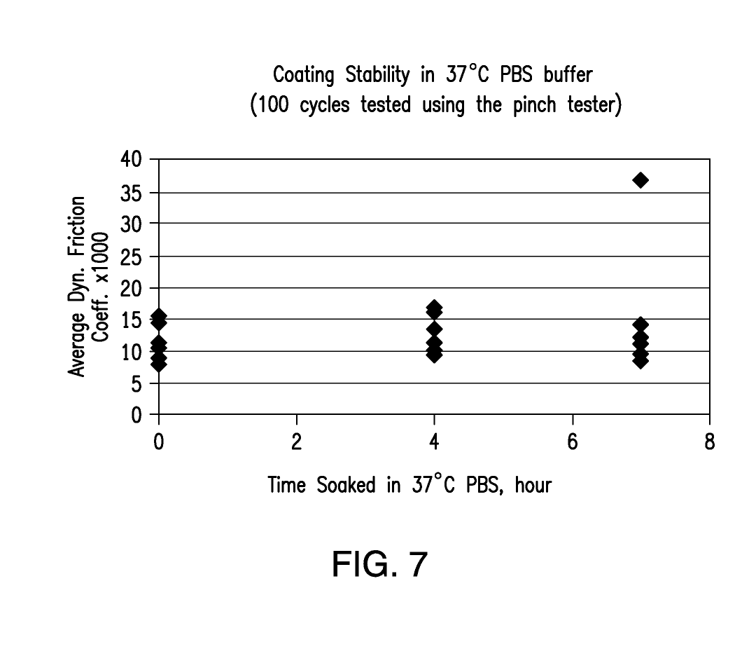

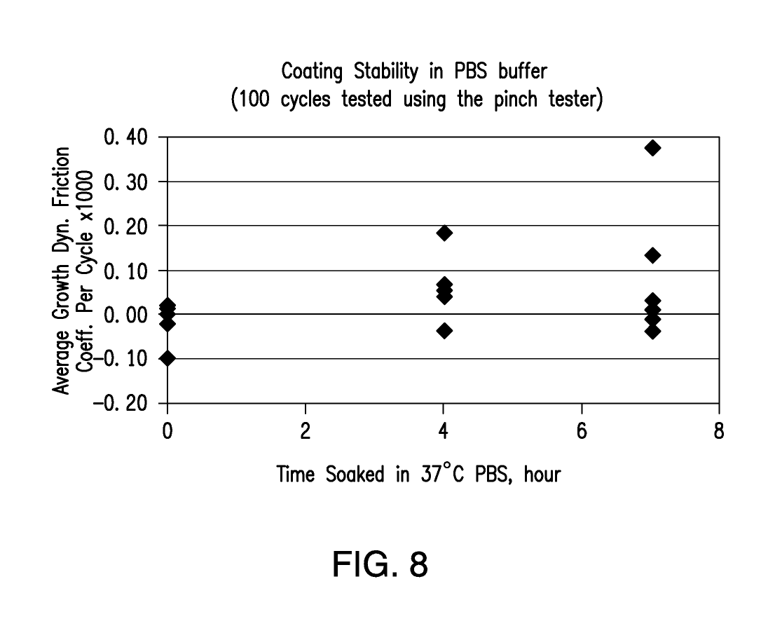

The stability of the coating was tested by soaking the coated PETG rods in 37° C. PBS solution for 4 and 7 hours, respectively. The soaked samples were then tested immediately by using the pinch tester as described in Example 4. The samples without the treatment of PBS soaking were also tested for comparison. Six samples were tested for each soaking condition, i.e., 4 hours, 7 hours in 37° C. PBS solution and non-soaking, respectively. Three pinch forces, 770 grams, 1070 grams and 1370 grams, were used for testing the six samples, in which two of the samples were tested using one of the pinch forces. One hundred cycles were conducted for each testing. The average friction coefficient of the 100 cycles was calculated, so was the growth of the friction coefficient per cycle. The results are shown in FIGS. 7 and 8. After being soaked in 37° C. PBS solution for 4 hours, all of the six tested samples had similar friction coefficients as those of untreated samples, i.e., between 0.01 and 0.015. Five out of the six tested samples that soaked in 37° C. PBS solution for 7 hours also showed unchanged friction coefficient. The data in FIG. 4 indicated that the durability of the coating did decrease slowly over time when soaked in 37° C. PBS solution. However, five of the six samples soaked for 7 hours had the growth of friction coefficient smaller than 0.15×10⁻³ per cycle, which meant the total increase of friction coefficient was less than 0.015 after testing for 100 cycles in the pinch tester. The durability of the coating was still acceptable after 7 hours in 37° C. PBS solution. Statistical t-tests were conducted for the data in FIGS. 7 and 8 respectively. The t-tests rejected the hypotheses at 5% significant level that the friction coefficient and the growth of coefficient per cycle increased with the time soaked in 37° C. PBS solution. The data in FIGS. 7 and 8 indicated the hydrophilic coating had good PBS resistance.

### Example 14

In this example, the performance of a bilaminar coating after accelerated aging was tested, in which a Cr(III) sulfate cross-linked poly(acrylic acid) was used as the top-coat.

The samples were prepared using the same formulation and process as those in Example 11.

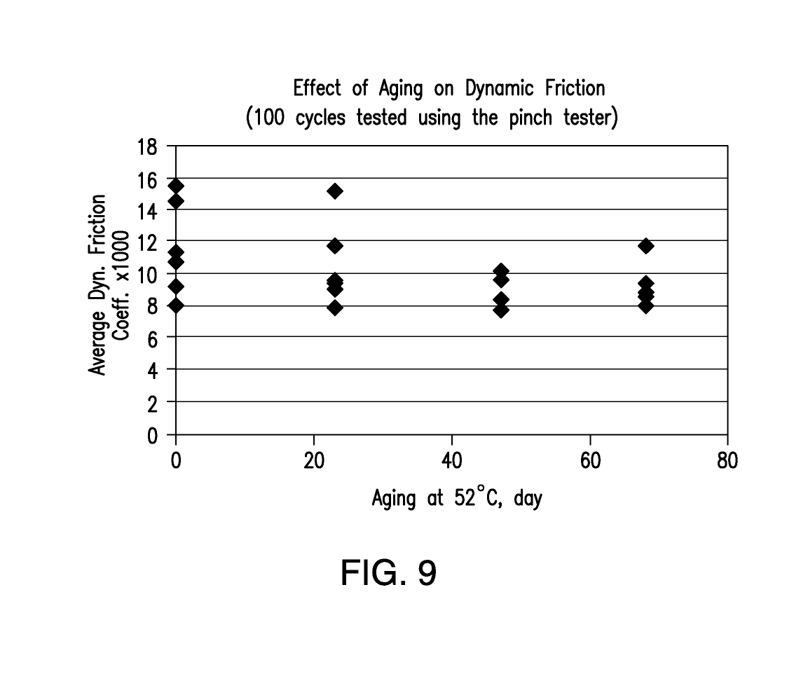

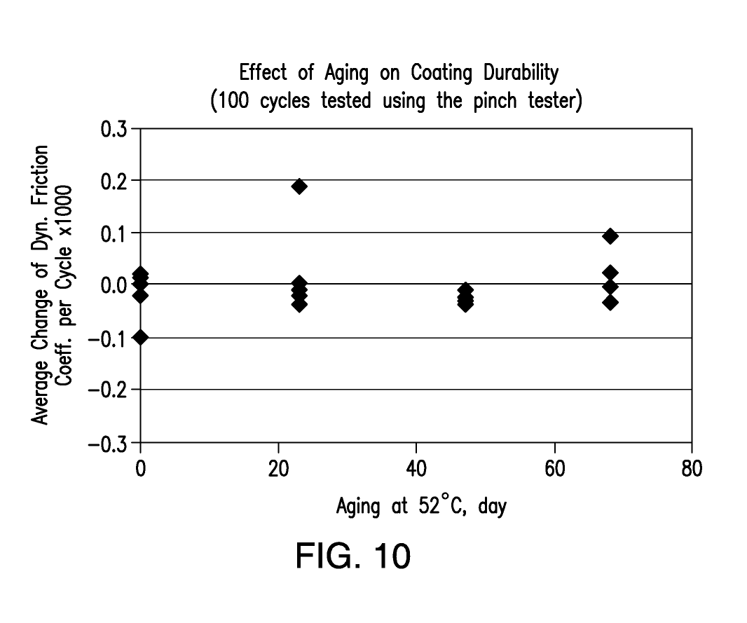

The accelerated aging was conducted in a 52° C. oven. The PETG samples with finished coating were packed in plastic sleeves then wrapped with aluminum foil. The samples were aged in a 52° C. oven for 23, 47 and 68 days, respectively. The coating performance was tested by using the pinch tester as described in Example 4. Six samples were tested for each aging condition, respectively. Six samples without aging were also tested as control. Three pinch forces, 770 grams, 1070 grams and 1370 grams, were used for testing the six samples, in which two of the samples were tested using one of the pinch forces. One hundred cycles were conducted for each testing. The average friction coefficient of the 100 cycles was calculated, so was the growth of the friction coefficient per cycle. The results are shown in FIGS. 9 and 10. The coating showed a slight decrease of friction coefficients over aging at 52° C. In FIG. 10, the coating durability was measured by the change of friction coefficient per cycle. All of the eighteen aged samples but two had durability similar to that of non-aged samples. Statistical t-tests were conducted for the data. The t-tests rejected the hypotheses at 5% significant level that the growth of coefficient per cycle increased with aging time.

The accelerated aging of 68 days in 52° C. is equivalent to one and half years of aging at room temperature (22° C.). The data in FIGS. 9 and 10 indicated the finished dry coating had shelf-life longer than one and half years.

The invention can be modified in ways that will be apparent to those skilled in the art. Such modifications should be considered within the spirit and scope of the following claims.

What is claimed is:

1. A composition comprising a substrate having a bilaminar coating, the bilaminar coating comprising a polymeric top-coat that is covalently grafted to a base-coat, the base-coat being firmly adhered to the substrate, wherein the top-coat is chemically cross-linked by chromium (III) ion, wherein the top-coat has superior durability and stability due to its cross-linked structure.

2. The composition according to claim 1, wherein the bilaminar coating is biocompatible.

3. The composition according to claim 1, wherein the bilaminar coating is hydrophilic and lubricious when contacted with aqueous fluid.

4. The composition according to claim 1, wherein the bilaminar coating is sterilized by one or more of the group consisting of gamma-rays, E-beams, and ethylene oxide.

5. The composition according to claim 1, where the top-coat polymer comprises monomer units from at least one monomer having a carboxylic acid/carboxylate functional group.

6. The composition according to claim 5, wherein the top-coat constitutes a material selected from at least one of the following carboxylic acid containing polymers: poly(acrylic acid), poly(methacrylic acid), poly(acrylic acid-acrylamide), and copolymers consisting of one or more of carboxylic acid containing monomers such as acrylic acid, methacrylic acid, itaconic acid, acryloxypropionic acid, isocrotonic acid, 3-butene-1,2,3-tricarboxylic acid, and maleic anhydride, and any acidic monomer capable of copolymerization with suitable monomers to form hydrophilic polymers.

7. The composition of according to claim 1, wherein the chromium (III) ion comprises a cross-linking agent for a top-coat polymer.

8. The composition according to claim 7, wherein a ratio of chromium (III) ion to polymer comprising the top coat is between 0.25 to 10% by weight.

9. The composition according to claim 7, wherein the top coat includes a water soluble chromium (III) compound, said compound providing the chromium (III) ion.

10. The composition according to claim 9, in which said compound is selected from the group consisting of chromium(III) acetate hydroxide, chromium(III) chloride, chromium(III) nitrate, chromium(III) phosphate, chromium(III) potassium sulfate dodecahydrate, chromium(III) sulfate and chromium(III) tris(2,2,6,6-tetramethyl-3,5-heptanedionate).

11. The composition according to claim 9, wherein the top-coat includes chromium (VI) in solution with a reducing agent, wherein the chromium (III) ion is provided by reduced chromium (VI).

12. The composition of claim 11, wherein the reducing agent is selected from the group consisting of sodium bisulfite and thiourea.

13. The composition of claim 9, wherein the top-coat includes chromium (II) in solution with an oxidizing agent, wherein the chromium (III) ion is provided by oxidized chromium (II).

14. The composition according to claim 1, wherein said base-coat comprises functional groups capable of covalent attachment of the base-coat polymer to the top-coat.

15. The composition according to claim 14, wherein said base-coat comprises a material selected from the group consisting of an acrylic polymer solution, an acrylic polymer dispersion, a polyurethane dispersion, and an acrylic polyurethane hybrid dispersion, the base-coat further comprising carboxylic acid groups, or carboxylic acid in combination with isocyanate and hydroxyl functional groups.

16. The composition according to claim 15, wherein the acrylic polymer has at least one acidic monomer, which is selected from the group consisting of acrylic acid, methacrylic acid, itaconic acid, acryloxypropionic acid, 3-butene-1,2,3-tricarboxylic acid, and maleic anhydride.

17. The composition according to claim 14, wherein said acidic monomer is present in an amount of about 0.1-10 mole percent.

18. The composition according to claim 15, wherein said polyurethane and acrylic-polyurethane hybrid dispersions comprise polymers that have pendant organic acid groups, including carboxylic acid and its neutralized salts.

19. The composition according to claim 15, wherein the base-coat includes at least one cross-linking agent.

20. The composition according to claim 19, wherein the cross-linking agent comprises one or more materials selected from the group consisting of polyfunctional aziridine, isocyanate and epoxy.
